(19) United States
(12) Patent Application Publication
(10) Pub. No.: US 2003/0007014 A1
(43) Pub. Date: Jan. 9, 2003

(54) User interface system for composing an image page layout

(76) Inventors: Scott John Suppan, Allentown, PA (US); John D. Haley, Honey Brook, PA (US)

Correspondence Address: Siemens Corporation, Intellectual Property Department, 186 Wood Avenue South, Iselin, NJ, 08830, US

(21) Appl. No.: 10/173,081

(22) Filed: Jun. 17, 2002

Related U.S. Application Data
(60) Provisional application No. 60/300,739, filed on Jun. 25, 2001.

(51) Int. Cl. G09G 5/00

(52) U.S. Cl. 345/853

(57) ABSTRACT

A user interface system supports organization of hierarchies of image elements for incorporation in an XML (or other language) data specification. The system further supports generation of image representative code from the data specification and associated ancillary specifications including label, tool tip, help and history specification data, for example. A user interface system for composing a layout of an image page suitable for display on a display device includes a user interface image generator. The generator provides data representing a displayable image window indicating a hierarchical organization of items representing image elements available to be included in an image page. The hierarchical organization of items links a parent item representing a first image element with a child item representing a second image element to be contained within the first image element. The system also includes a user interface command processor for initiating incorporation of both the first and second image elements in the image page, the second image element being located within the first image element, in response to user selection of corresponding parent and child items in the image window.

This is a non-provisional application of provisional application serial No. 60/300,739 by J. D. Haley et al. filed Jun. 25, 2001.

### FIELD OF THE INVENTION

This invention concerns a user interface system facilitating for composing a layout of an image page suitable for display on a display device, for example.

### BACKGROUND OF THE INVENTION

The need to create display images and electronic forms for web based applications is both common and widespread. A number of known systems support user creation of display images for web based or other applications. Such systems enable user development of executable code for providing a desired display image incorporating required image elements (such as prompt elements, menus, icons, buttons and other features, for example). These systems generate a desired display image in executable code such as HTML (HyperText Markup Language), DHTML (Dynamic HyperText Markup Language), XML (Extensible Markup Language), or Java code, for example.

The known systems used for creating display images for web based or other applications have a number of deficiencies. These systems typically offer limited capability to re-use code representing particular display image elements and have limited capability for generating, aligning and adapting image element labels such as prompt element option lists, button names etc. Image element labels are typically required to be newly generated or existing labels need to be re-aligned and adapted to tailor an existing form for a new use. This is necessary in converting a form for use in different countries requiring different languages (French, German, Japanese etc.) or to convert a form for use by a different audience such as tailoring an adult form for use by children, for example. Known systems also typically lack an architecture facilitating addition and update of display image elements and procedures invoked by user interaction with such image elements. A system according to invention principles addresses these deficiencies and derivative problems.

### SUMMARY OF INVENTION

A user interface system supports organization of hierarchies of image elements for incorporation in an XML (or other language) data specification. The system further supports generation of image representative code from the data specification and associated ancillary specifications including label, tool tip, help and history specification data, for example. A user interface system for composing a layout of an image page suitable for display on a display device includes a user interface image generator. The generator provides data representing a displayable image window indicating a hierarchical organization of items representing image elements available to be included in an image page. The hierarchical organization of items links a parent item representing a first image element with a child item representing a second image element to be contained within the first image element. The system also includes a user interface command processor for initiating incorporation of both the first and second image elements in the image page, the second image element being located within the first image element, in response to user selection of corresponding parent and child items in the image window.

### BRIEF DESCRIPTION OF THE DRAWING

FIG. 1 shows a system for creating an XML representation of an image display such as a form, according to invention principles.

FIG. 2 shows a user interface display image used in creating an electronic form, according to invention principles.

FIG. 3 shows a user interface display image used in adding a composite component to an electronic form, according to invention principles.

FIG. 4 shows a first user interface display image used in a first mode of adding a composite component to an electronic form, according to invention principles.

FIG. 5 shows a second user interface display image used in a second mode of adding a composite component to an electronic form, according to invention principles.

FIG. 6 shows a user interface display image for presenting acquired form creation related information to a user, according to invention principles.

FIG. 7 illustrates the data fields in a label property editing display image, according to invention principles.

FIG. 8 illustrates the data fields in a tool tip property editing display image, according to invention principles.

FIG. 9 shows a user interface display image supporting creation of display image element associated help instructions, according to invention principles.

FIG. 10 shows a user interface display image supporting creation of a procedure responsive to activation of a designated image element, according to invention principles.

FIG. 11 shows a second user interface display image supporting creation of a procedure responsive to activation of a designated image element, according to invention principles.

FIG. 12 illustrates XML presentation specification image element code, according to invention principles.

### DETAILED DESCRIPTION OF PREFERRED EMBODIMENTS

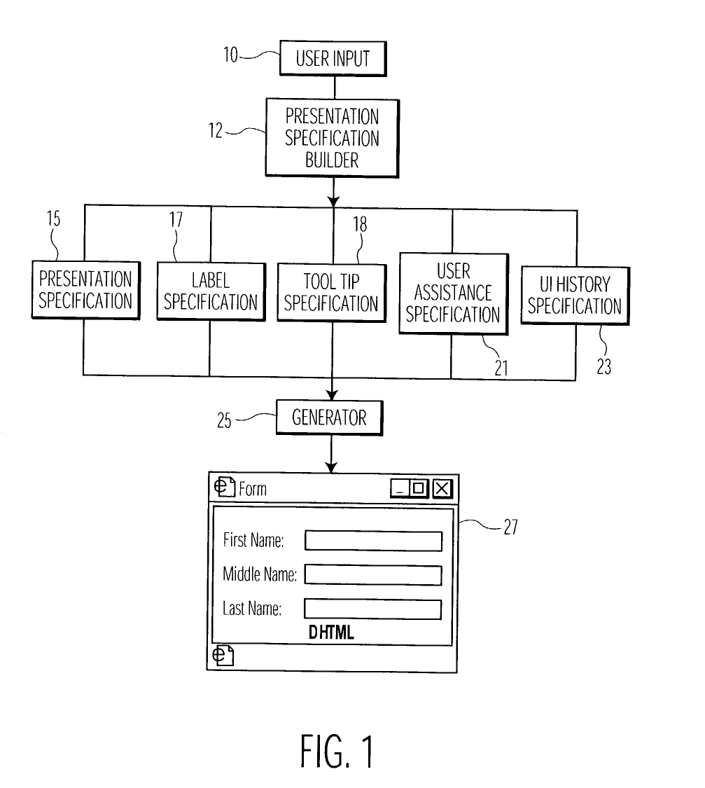

FIG. 1 shows a system for creating an XML representation of an image display such as a form. The system supports creating and maintaining specifications which fully describe user interface images for web based applications. The disclosed system enables users to assemble, organize, and modify hierarchies of user interface components in the form of an XML presentation specification. XML (Extensible Markup Language) is used to encode structured data passed between computer systems and is determined by a standard maintained by the World Wide Web Consortium (see http://www.w3.org/XML). In the FIG. 1 system XML format data specification 15 (representing object oriented data), as well as XML compatible label, tool tip, user assistance and UI history specifications 17, 18, 21 and 23 respectively, are produced by specification builder 12 in response to user commands and preferences 10. Unit 12 includes editors for use in creating corresponding XML specifications 15-23 and an individual specification provides corresponding particular features of a user interface display image. A user employs specification builder 12 to generate specifications 15-23 representing a form for display as a user interface display image incorporating user selectable image elements.

A user selectable image element as used herein comprises a button, a prompt element, a status indicator, a menu item, an inputbox, checkbox, a prompt element with a list of selectable options and a data entry element and other user interactive and viewable image features. Presentation specification 15 determines the image elements to be incorporated in a desired web based form and specifications 17-23 determine associated labels and other features of the form. The system enables users to create and maintain XML based specifications 15-23 representing forms incorporating image elements. Code generator 25 parses and processes XML specifications 15-23 to create a web-based form 27 in a user selected code language such as DHTML or Jscript, (or in another embodiment a different code language) for use in a user interface for a web-based or other application, for example. Code generator 25 thereby advantageously automatically generates DHTML or Jscript code that would otherwise have to be manually created.

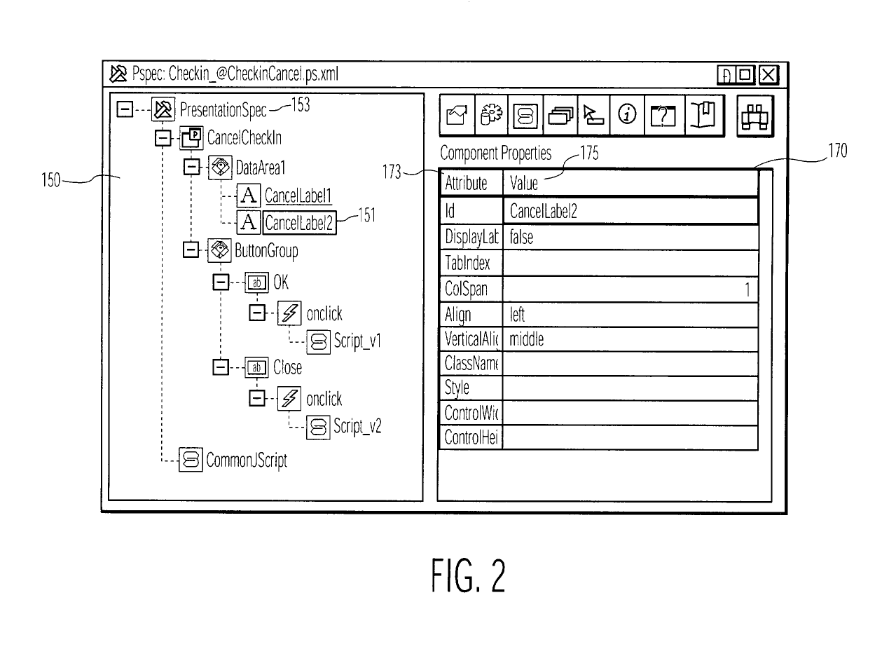

FIG. 2 shows a user interface display image supporting user creation of presentation specification 15 with specification builder 12 (FIG. 1). Presentation specification 15 determines a hierarchical arrangement of image elements to be incorporated in a desired web based form. It also defines the layout, the style and appearance, form type, and content of the web based form. The user interface display image of FIG. 2 of builder 12 supports user selection and arrangement of various user interface image elements in a form by providing a point and click graphical user interface for constructing a hierarchy of image elements from a library of pre-existing image elements. The library contains image elements (as previously described) such as a button, inputbox, label, checkbox, prompt element, prompt element with option list, etc. Window 150 of the display image of FIG. 2 comprises a hierarchical arrangement of items (such as item 151) contained in a presentation specification (specification 15 of FIG. 1 shown as the encompassing item 153 in window 150) representing corresponding image elements and associated attributes incorporated in a form represented by the presentation specification.

The FIG. 2 user interface image display supports builder 12 editing functions and enables addition of an image element from the library to a target form and also supports user deletion, movement or copying of image elements within a form or from a previously created form to the target form. This may be done by cutting and pasting type operations or other types of editing operations, as known. The builder 12 editor assigns different identifiers to individual image elements added to a form enabling individual image elements to be separately identified. The builder 12 editor supports change of image element identifier but requires such a changed identifier to be different from other image element identifiers in a target form. This is done to avoid identifier duplications in DHTML code and resulting form operation error. Window 170 of the builder 12 display image of FIG. 2 supports user modification of values of specific properties of a selected image element contained in a property sheet. Thereby, for example, a user is able to change the style or appearance of an image element (such as CancelLabel2 image element represented by displayed item 151) by selecting values 175 of corresponding image element attributes 173. Builder 12 also advantageously supports user grouping of (newly created or pre-existing) image elements and related items into a reusable composite component. A composite component is a group of image elements and related data arranged into a meaningful and reusable pattern. Composite components may be created and shared among users and the FIG. 1 system architecture advantageously supports incorporation of user interface composite components and image elements derived from external sources and created by a third party with minor (or zero) user programming effort.

In response to user commands, builder 12 (FIG. 1) produces XML format data specification 15 and XML compatible label, tool tip, user assistance and UI history specifications 17, 18, 21 and 23 respectively. The XML declaration of labels, tool tips, and user assistance data separate from form layout determinative data specification 15 facilitates modification of a form for different languages (e.g., French, German etc.) without necessitating alteration of the layout of a form as determined by data specification 15. This separate specification architecture also facilitates addition and modification of user interface image elements and maintenance of historical information about content of previous user interface form versions, for example. The architecture of the FIG. 1 system also supports creation of user-defined event handling procedures (e.g. in Jscript or DHTML) for determining functions to be performed in response to user activation of an image element in a form. The FIG. 1 system further facilitates creation of forms with multiple different types of user interactive image elements (prompt boxes with or without option lists, data entry boxes etc.) and facilitates changing properties of image elements affecting the layout, appearance and functions initiated via a form. The FIG. 1 system also automatically updates specifications 15-23 to accommodate a change to a user selected code language to be produced by generator 25 for web-based form 27. Builder 12 of the FIG. 1 system also automatically creates and aligns labels for user interface image elements in form 27.

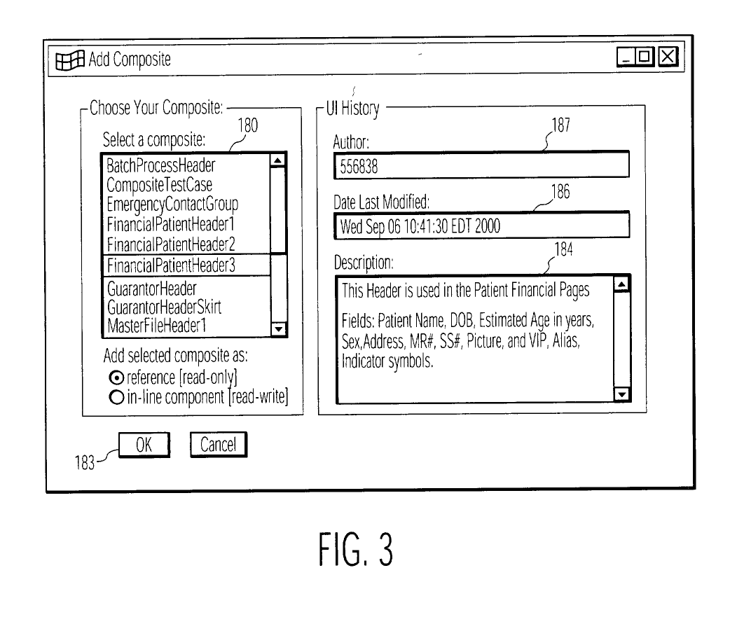

A composite component created using builder 12 may be incorporated in a form in different modes. A composite component may be incorporated in a form in either a reference component mode or in an inline component mode, for example. A composite component is selected by a user for incorporation in a form, in either mode, via a user interface display image illustrated in FIG. 3. In response to user selection of a composite component in window 180, its associated attributes including author, date last modified and description are indicated in corresponding display items 187, 186 and 184 respectively. The mode of incorporation (i.e. reference component mode or inline component mode) is also selected via activatable items shown below window 180 and the selected composite component is incorporated in a target form in response to user selection of image element 183.

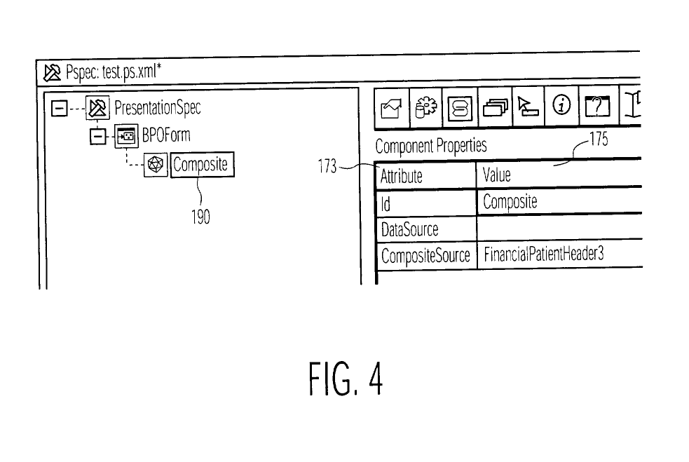

In reference component mode, a composite component is incorporated in a form as a reference in similar fashion to a link or a pointer. Instead of actually inserting a mass of individual image elements into form representative data comprising a component hierarchy, a single composite component is added which points, or is linked, to a composite component definition. FIG. 4 shows a user interface display image used for adding a composite image element to a target electronic form in reference mode. The added composite component 190 (FIG. 4) is shown incorporated into form representative data of a presentation data specification 15 (FIG. 1) representing a component hierarchy. In this reference mode, added single composite component 190 is linked to a composite component definition comprising attributes 173 and associated attribute values 175. This reference mode of adding a composite component advantageously enables any changes made to the component definition properties (including attributes and associated values) to be automatically reflected in the target electronic form which incorporates the composite component via the linking mechanism.

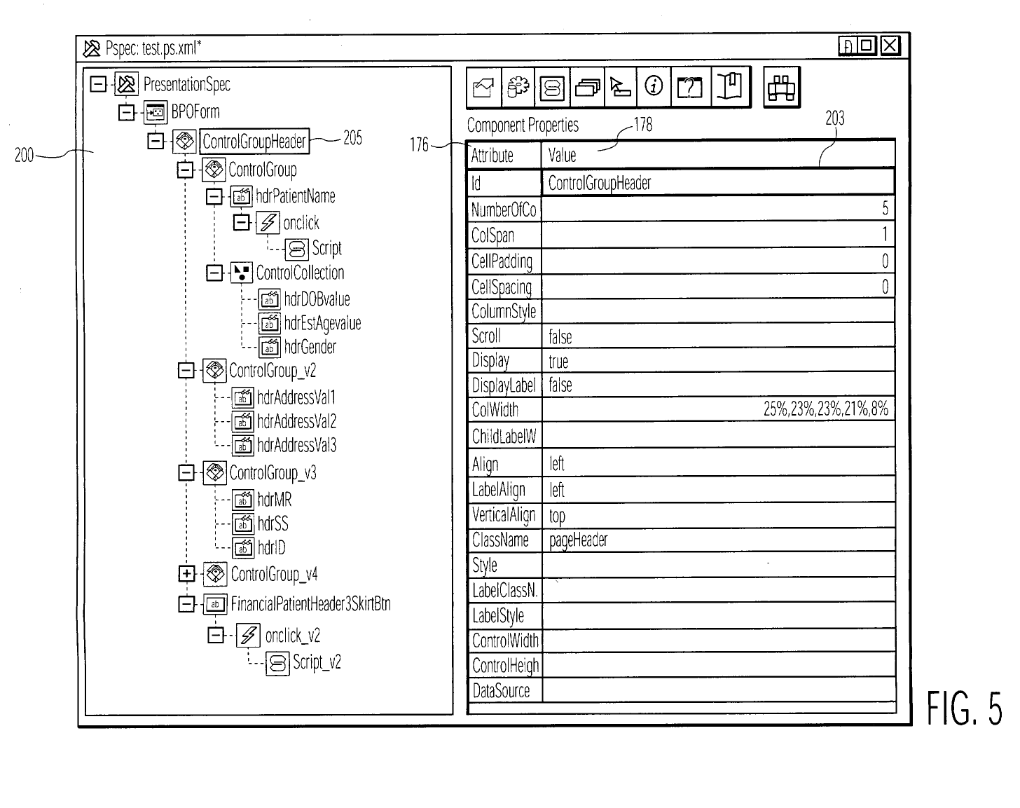

In an inline component mode, individual image elements comprising the composite component are incorporated into form representative data of a presentation data specification 15 (FIG. 1) representing a component hierarchy. FIG. 5 shows a user interface display image used in incorporating a composite component in an electronic form in inline component mode. The image elements comprising added composite component 205 (FIG. 5) are indicated by hierarchically structured image element representative items in window 200 incorporated into form representative data of a presentation data specification 15 (FIG. 1) representing the form component hierarchy. In this inline mode, individual image element attributes 176 and associated attribute values 178 are indicated in window 203. In this inline mode of incorporating a composite component in a form, the form is isolated from changes made to the properties of the overall composite component definition but allows a user to modify an individual internal component within the composite component. This advantageously gives a user flexibility in applying a composite component in an interface form especially in a case in which an overall composite component does not have to meet particular specific requirements.

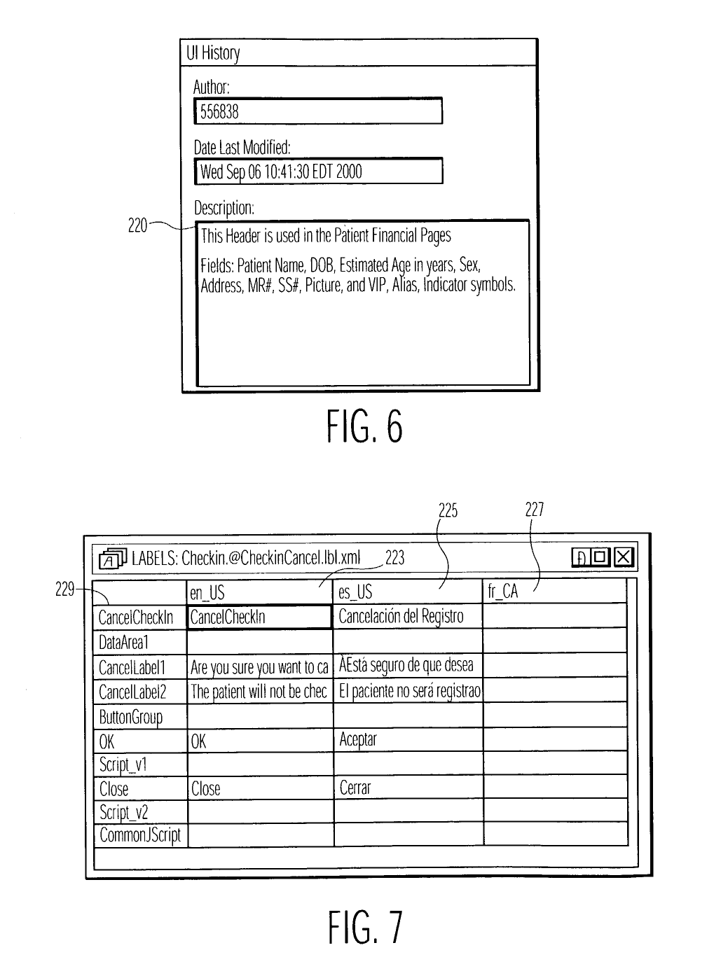

Builder 12 (FIG. 1) automatically acquires form creation related information and retains it in UI history specification 23 during user creation of a form. The acquired information includes author identifier, a date a form was last modified, a conversion key identifier, and comments by the author. The author comments are retained in a description field which may also be used by a form author to convey special form handling instructions or other pertinent information concerning form characteristics. The conversion key identifier identifies a desired form representative code language (to be produced by code generator 25) and is used in converting XML specifications to a desired form representative code language. FIG. 6 shows a user interface display image for presenting acquired form creation related information to a user. The display image indicates fields showing the author identifier, a date a form was last modified and a descriptive field 220 containing comments by an author.

Builder 12 includes a Label Specification Editor for receiving and processing input text for use as image element labels and for creating label specification 17. FIG. 7 illustrates the data fields in a label property editing display image and structure of a form label specification 17 (FIG. 1). The label properties are maintained in a table structure in FIG. 7 including text strings in multiple languages that are associated with specific image elements in a form. The text strings comprise labels associated with these specific image elements in the form. Column 229 includes image element identification names and columns 223, 225 and 227 include labels in English, Spanish and French respectively, associated with a corresponding image element. The Close image element, for example, has an associated English label (Close) and Spanish label (Cerrar). Builder 12 supports label editing by enabling a user to select and amend, delete or replace label properties detailed in the property sheet type format of FIG. 7.

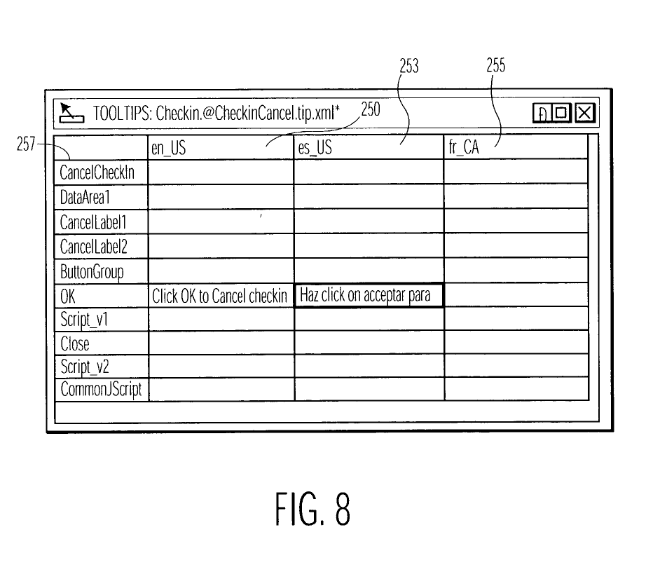

Builder 12 further includes a Tool Tip Specification Editor for receiving and processing input tool tip text associated with an image element in a form and for creating Tool Tip specification 18. Tool tip text is descriptive text that briefly appears when a mouse cursor, for example, is positioned over a user interface image element for a specified amount of time. FIG. 8 illustrates the data fields in a tool tip property editing display image. The Tool Tip properties are maintained in a table structure including text strings in multiple languages that are associated with specific image elements in a form. The text strings comprise tool tips associated with these specific image elements in the form. Column 257 includes image element identification names and columns 250, 253 and 255 include tool tips in English, Spanish and French respectively, associated with a corresponding image element. The OK image element, for example, has an associated English tool tip (Click OK to Cancel checkin) and a corresponding Spanish language tool tip. Builder 12 supports tool tip editing by enabling a user to select and amend, delete or replace tool tip properties detailed in the property sheet type format of FIG. 8.

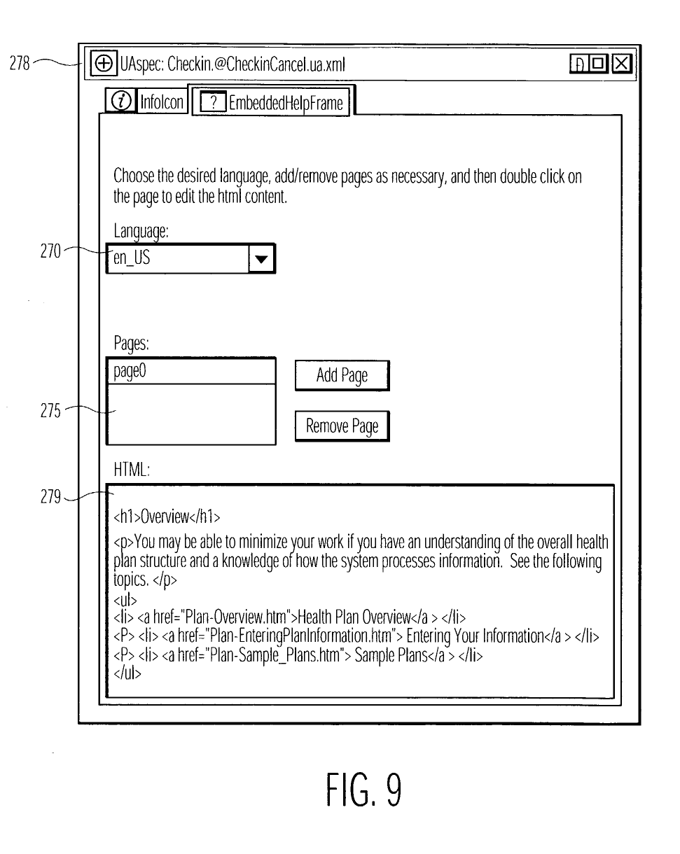

Builder 12 further includes a User Assistance specification Editor for receiving and processing input, form or topic, user assistance text associated with an image element in a form and for creating User Assistance specification 21. The User Assistance Specification 21 incorporates a table of text in multiple languages associated with particular image elements in a form. Assistance text concerning a particular topic typically comprises a single paragraph whereas assistance text concerning a form may occupy multiple text pages. The User Assistance Text and properties are maintained in a table structure including text in multiple languages that are associated with specific image elements in a form. FIG. 9 illustrates a user interface display image supporting creation of display image element associated user assistance text for a form. FIG. 9 illustrates a user interface image supporting creation or amendment of user assistance text associated with selected checkincancel image element identified in item 278. A user selects a desired text language for the checkincancel assistance text via image element 270 and the particular text page to view and amend via image element 275. A user is able to add text (or amend existing text) in the selected page in the desired language via window 279. Builder 12 (FIG. 1) supports user assistance text editing by enabling a user to select and amend, delete or replace user assistance text via the user interface display image of FIG. 9.

User Interface History Specification 23 (FIG. 1) of a particular form advantageously includes a version identifier identifying a version of specifications 15-21. Prior to code generator 25 parsing and processing XML specifications 15-23 to create web-based form 27 in a user selected code language, generator 25 compares the specification 23 version identifier with an internally stored corresponding form version identifier. The corresponding internally stored version identifier is updated each time a change is made to an image element by changing specifications 15-21 for a particular form. Consequently, if generator 25 identifies that the UI history specification 23 version identifier is different to the internally stored version identifier, generator 25 initiates a procedure to incorporate the latest version of image element XML definition code to ensure the latest version specifications 15-21 are employed. Following execution of this procedure UI history specification 23 is updated to indicate the latest version identifier for specifications 15-21 to ensure the procedure is not erroneously repeated. Thereby, new XML code determining a new InputBox image element, for example, is automatically used in creating a form upon initiation of form re-generation by generator 25. Such re-generation may be initiated in response to a user updating a form, modifying the form for a new language or for other reasons.

Builder 12 (FIG. 1) supports inclusion of user-defined event handling procedures (e.g. in Jscript or DHTML) in Presentation Specification 15 for determining functions to be performed in response to user activation of an image element in a form. An individual image element in a form supports a variety of events and associated procedures. The various different events are initiated by corresponding different ways of activating the individual image element such as by a single mouse click, by holding the image element in an active state (e.g. by a continuing mouse key depression), by a double mouse click or by positioning a cursor over an image element, for example. Builder 12 enables a user to associate a user determined procedure, or to associate an object method, with an image element to be performed in response to a corresponding particular manner of activation of this image element.

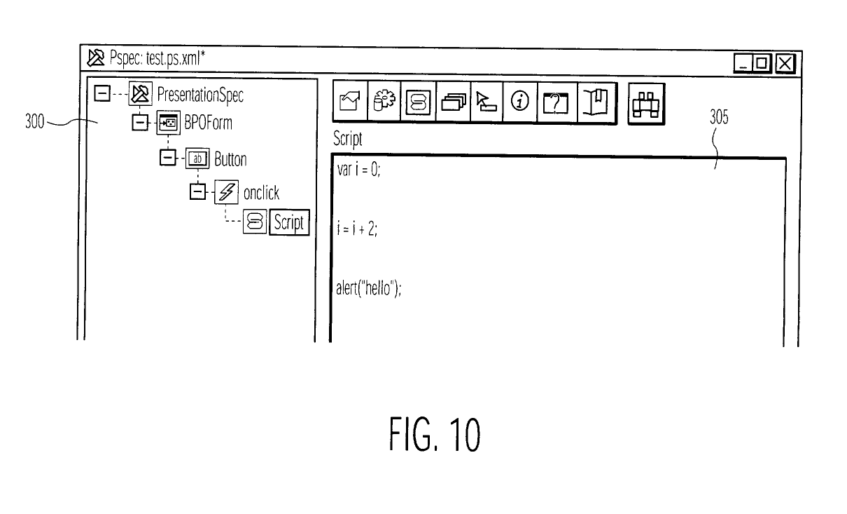

FIG. 10 shows a user interface display image supporting creation of a procedure responsive to activation of a designated image element. Specifically, window 300 enables a user activatable image element (a button) to be associated with a user-defined event handling procedure (represented by the onclick item hierarchically linked to the button in window 300). Window 300 also enables the user-defined event handling procedure to be associated with a script procedure represented by the Script item hierarchically linked to the onclick item in window 300. Upon a particular manner of user activation of the form button image element (a single mouse click in this example), the script procedure is executed to perform a desired function. A user may enter, view, amend or delete the script procedure via window 305.

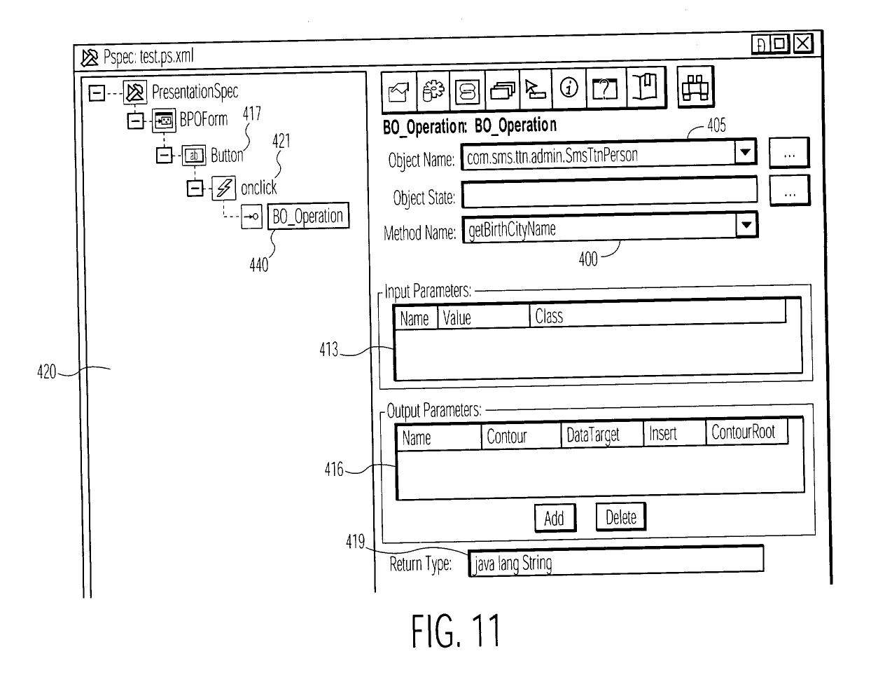

FIG. 11 shows another user interface display image supporting creation of a procedure responsive to user activation of a designated image element. In the example above, a user-defined event handling procedure (represented by onclick item 421) is hierarchically linked to a button 417 in window 420 and to a procedure 400 (getBirthCityName represented by item 440 in window 420) of identified object 405. Input parameters to be passed to procedure 400 and output parameters to be produced by procedure 400 are user determined via display boxes 413 and 416 respectively. The type of output produced by procedure 400 (e.g., a java language string) is identified via display box 419. Upon a particular manner of user activation of the form button image element (a single mouse click in this example), procedure 400 is executed to get a birth city name of a person associated with identified object 405.

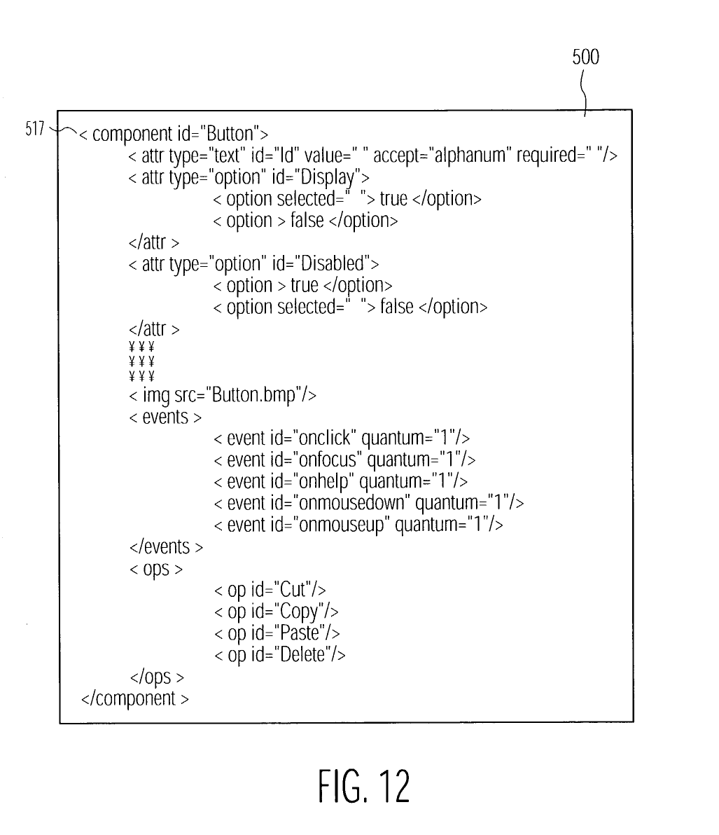

FIG. 12 shows XML presentation specification code 500 comprising an exemplary XML file determining user interface image elements (e.g., a button) for use within the system and defining different events associated with activation of the button (component 517). This file advantageously facilitates incorporation of third party sourced user interface image elements. An image element description is added in to code 500 of FIG. 12 by incorporating definition code for another image element into code 500. Builder 12 (FIG. 1) automatically edits the added image element code in accordance with predetermined syntax rules for presentation specification 15 format to produce XML code compatible with the presentation specification 15 (FIG. 1) and code 500 (FIG. 12). Builder 12 (FIG. 1) also supports manual intervention and user editing of the added image element code to produce XML code compatible with the presentation specification 15 and code 500 in those cases where automatic conversion cannot be accomplished.

The data structure manipulation, processing and system presented in FIGS. 1-12 are not exclusive. Other system configurations and user interface display image formats and functions may also be derived in accordance with the principles of the invention to accomplish the same objectives. Further, the inventive principles may be advantageously employed in any systems involving hierarchical data structures including units that include sub-units. Such systems may include, business, database, architecture, or general design applications. As such, the described user interface image elements may instead comprise three dimensional objects used in landscaping, for example. Thereby a landscape design may be derived by adding various plots to a larger plot. The smaller plots could contain configurations of various shrubbery, flowers, or trees. Instead of generating DHTML and Jscript, code generator 25 may generate a three dimensional representation of the landscape in Virtual Reality Modeling Language (VRML), for example.

What is claimed is:

1. A user interface system for composing a layout of an image page suitable for display on a display device, comprising:
a user interface image generator for providing data representing a displayable image window presenting a hierarchical organization of a plurality of items representing image elements available to be included in an image page, said hierarchical organization of said plurality of items linking a parent item representing a first image element with a child item representing a second image element to be contained within said first image element; and
a user interface command processor for initiating incorporation of both said first and second image elements in said image page, said second image element being located within said first image element, in response to user selection of corresponding parent and child items in said image window.

2. A user interface system according to claim 1, wherein
said hierarchical organization of said plurality of items linking a second parent item representing a third image element with a second child item representing a procedure to be executed in response to user selection of said third image element in said image page.

3. A user interface system according to claim 1, wherein
said parent item represents a composite group of image elements.

4. A user interface system according to claim 3, wherein
said parent item represents a composite group of image elements and said user interface command processor initiates incorporation of said composite group of image elements in said image page in a user selectable form of at least one of, (a) a group of non-modifiable image elements and (b) a group of individually modifiable image elements, selected in response to user command.

5. A user interface system according to claim 3, wherein
said composite group of image elements is selected from a library of predetermined composite groups of image elements.

6. A user interface system according to claim 1, wherein
said second image element comprises a text label to be contained within said first image element and said hierarchical organization determines said text label and said first image element are automatically aligned.

7. A user interface system according to claim 1, wherein
an image element comprises at least one of, (a) a button, (b) a prompt element, (c) a status indicator, (d) a menu item, (e) a checkbox, (f) a prompt element with a list of selectable options, (g) an input box and (h) a data entry element.

8. A user interface system according to claim 1, wherein
said user interface image generator and said user interface command processor comprise one or more executable procedures.

9. A user interface system for composing a layout of an image page suitable for display on a display device, comprising:
a user interface image processor for providing data representing a displayable image window presenting a hierarchical organization of a plurality of items representing image elements available to be included in an image page, said hierarchical organization of said plurality of items linking a parent item representing a first image element with a child item representing a composite group of image elements to be contained within said first image element; and
a user interface command processor for initiating incorporation of both said first image element and said composite group of image elements in said image page, said composite group of image elements being located within said first image element, in response to user selection of corresponding parent and child items in said image window.

10. A user interface system according to claim 9, wherein
said user interface command processor initiates incorporation of said composite group of image elements in said image page in a user selectable form of at least one of, (a) a group of non-modifiable image elements and (b) a group of individually modifiable image elements, selected in response to user command.

11. A user interface system for composing a layout of an image page suitable for display on a display device, comprising:
a user interface image generator for providing data representing a displayable image window presenting a hierarchical organization of a plurality of items representing image elements available to be included in an image page, said hierarchical organization of said plurality of items linking a parent item representing a first image element with a child item representing at least one of,
(a) a second image element to be contained within said first image element in said image page and
(b) a procedure to be executed in response to user selection of said first image element in said image page; and
a user interface command processor for initiating incorporation of said first image element in said image page, in response to user selection of said corresponding parent item in said image window.

12. A method for composing a layout of an image page suitable for display on a display device, comprising the steps of:
initiating display of an image window presenting a hierarchical organization of a plurality of items representing image elements available to be included in an image page, said hierarchical organization of said plurality of items linking a parent item representing a first image element with a child item representing a second image element to be contained within said first image element; and
initiating incorporation of both said first and second image elements in said image page, said second image element being located within said first image element, in response to user selection of corresponding parent and child items in said image window.

13. A method according to claim 12, wherein
said hierarchical organization of said plurality of items links a second parent item representing a third image element with a second child item representing a procedure to be executed in response to user selection of said third image element in said image page.

14. A method for composing a layout of an image page suitable for display on a display device, comprising:
initiating display of an image window presenting a hierarchical organization of a plurality of items representing image elements available to be included in an image page, said hierarchical organization of said plurality of items linking a parent item representing a first image element with a child item representing a composite group of image elements to be contained within said first image element; and
initiating incorporation of both said first image element and said composite group of image elements in said image page, said composite group of image elements being located within said first image element, in response to user selection of corresponding parent and child items in said image window.

15. A method according to claim 14, including the step of
initiating display of a user interface item enabling user selection of whether said composite group of image elements is to be included in said image as one of, (a) a composite group of non-modifiable image elements and (b) a group of individually modifiable image elements.
